(19) United States
(12) Patent Application Publication
(10) Pub. No.: US 2022/0243707 A1
(43) Pub. Date: Aug. 4, 2022

(54) Geothermal Energy System

(71) Applicant: Andrew Fleming, Ft. Collins, CO (US)

(72) Inventor: Andrew Fleming, Ft. Collins, CO (US)

(21) Appl. No.: 17/163,385

(22) Filed: Jan. 30, 2021

(51) Int. Cl. F03G 7/04; F24T 10/15; F24T 10/17

(52) U.S. Cl. CPC F03G 7/04; F24T 10/17; F24T 10/15

(57) ABSTRACT

The invention is a broadly dispatchable, optimized low to medium temperature (about 350° F. to 600° F.) geothermal energy production system to generate electricity. The invention comprises (i) a pipeline for the closed circulation of a working fluid which absorbs subterranean heat to create a superheated fluid during circulation, (ii) a pump for circulating the heatable fluid at high volumes, (iii) a chamber to convert the superheated fluid into a vapor, (iv) a heat exchanger to extract heat from the vapor, (v) an Organic Rankine Cycle engine (or similar device) powered by extracted heat and (v) a turbine driven by the Organic Rankine Cycle engine to produce electricity.

### BACKGROUND OF THE INVENTION

The Earth is a vast reservoir of energy. Temperatures at the Earth's core may exceed 10,000° F. and temperature in the upper mantle may exceed 2,000° F. Such temperatures represent an enormous energy store. Even much closer to the Earth's surface, temperatures can reach 400° F. to 600° F. Companies drilling oil wells at or below depths of 10,000 to 20,000 feet commonly encounter temperatures between 300° F. and 600° F. These temperatures can cause problems for oil and gas producers. For example, heat can destroy sensors as well as oil well instruments and tools. It can also destroy cement and drilling fluids unless mitigation efforts are implemented. On the other hand, those temperatures can be used to run geothermal power generators.

In this disclosure, the terms “low,” “medium” and “high” are relative. For example, a “medium temperature” geothermal system operates at the relatively low temperature range of 350° F. to 600° F. (compared to temperatures at the Earth's core of 10,000° F.). Those relatively “medium” temperatures are sufficient to allow the rapid uptake of significant amounts of energy into a working fluid in the described system. Hereafter, these temperatures are referred to as “hot” because they are hot enough to accomplish the desired task.

If one is not extracting gas or oil from depths of 10,000 feet or more, a pipeline installed and cemented into hot subsurface rocks can carry a fluid from the surface down into the hot rock formation. Rather than extracting petroleum products from hot rock formations, geothermal energy systems inject relatively cool (approximately 100° F.) working fluids into pipes from the surface down into hot rocks at a sufficient depth. At such depths, contact between the high conductivity pipe and the hot rock formations quickly heats the working fluid inside the pipes. At sufficient temperatures, the pumped working fluid is superheated under pressure (to prevent boiling of the working fluid), storing in the super-heated working fluid high levels of energy as a single-phase fluid. This super-heated working fluid has high enthalpy. That high enthalpic energy is returned to the surface in the returning super-heated working fluid. In another embodiment, the working fluid is heated under lower pressure to high temperatures creating a high energy vapor by boiling the working fluid into such a vapor. This high energy vapor is likewise returned to the surface.

In either case, the working fluid or vapor is returned to the surface where the heat energy therein can be extracted through various techniques to convert the energy into a more usable form. At its simplest, the heated fluid or vapor can be circulated through buildings as a source of heat. To produce electricity, the heat can be extracted from the superheated working fluid or the high energy vapor to produce steam to drive a turbine.

In a geothermal system using a high enthalpy working fluid, the pressurized working fluid has a boiling point under normal pressure lower than that of water. Under pressure and when pumped through the subsurface pipeline, the working fluid absorbs much more than enough energy to vaporize the liquid. However, the pressurized working fluid does not boil because of the applied pressure. Instead, it creates a superheated liquid. When the hot working fluid is returned to the surface, the pressure is released, causing approximately one quarter of the working fluid to vaporize rapidly. Most of the liquid remains, although much of the subsurface heat is in the vapor. In a heat exchanger, the high energy vapor transfers its heat to a supply of circulating water, converting the water to steam. That steam then drives a turbine, converting the energy to electricity.

One of the limitations of many alternative energy systems is the limited ability to scale operations up or down quickly to meet high and low demands. Solar energy and wind energy systems are notably limited by being operational only about 25% of the time because of darkness, clouds, calm, high winds or other unfavorable conditions. Neither can typically be scaled up except by building more solar panels or wind turbines. Known geothermal systems are not designed to be scaled up or down rapidly to meet high or low energy demand. In the present closed system and with the disclosed pipeline design with a vertical pipeline to transport a working fluid to the depth of a hot rock formation and a horizontal pipeline to allow heating contact between the hot rock formation and the working fluid, the pumping rate of the working fluid can be scaled up or down broadly by making the horizontal (and in some cases the vertical) pipeline element long enough to ensure sufficient heating of the largest expected flow necessary to meet the highest production demands above the average predicted demand. This is done by determining the maximum heat transfer based on the temperature of the rock formation through which the horizontal pipeline is placed in light of the type of working fluid used. This permits the rate of heating of the fluid to be increased or decreased on demand based on the known heat transfer characteristics of the pipeline of a known length placed within a rock formation of a known temperature. As a direct result, the extraction of heat from the working fluid as it is pumped out of the pipeline is equally scalable on demand, resulting in the ability to scale up or down the production of electricity broadly. Further increased scalability is achieved by additional wells and turbines/generators that can be brought on-line quickly to increase electricity production quickly. Thus, the system is broadly dispatchable providing 100% of the power required 24 hours per day, 7 days per week and 365 days per year across a range of demands.

### BRIEF DESCRIPTION OF THE INVENTION

In the preferred embodiment, the invention comprises a closed pipeline for circulating a working fluid into the Earth. A borehole is drilled vertically down into the Earth to a depth where the rock formation temperature is between approximately 300° F. and 600° F. The borehole has a diameter sized to have installed therein a pipe described more fully below for the circulation of a working fluid. At a suitable depth and temperature, the borehole is drilled to run approximately horizontally (relative to the Earth's surface) for a sufficient length such that a working fluid circulated through a pipeline disposed in the horizontal borehole will be heated to a desired temperature by thermal contact. For brevity, this approximately horizontal section of the borehole is referred generally as “horizontal.” The length of the horizontal borehole is determined by the need to maximize the average amount of energy absorbed into the working fluid at the highest determined rate of working fluid flow based on the temperature of the surrounding rock formation. In some embodiments there may be no horizontal section. In other embodiments it may be thousands of feet. The length of the horizontal borehole is then made longer than that in order to ensure safe operation. The total length of the horizontal borehole is determined by the need to operate the system safely and reliably while equally obtaining from the working fluid pumped through the pipeline in the borehole the amount of energy needed to produce electricity at anticipated demand levels. For a general example, if the temperature of the rock formation would necessitate 5,000 feet of horizontal circulating pipe to extract the maximum amount of energy from the rock formation into the working fluid, approximately 500 more feet of pipe may be installed to allow safe operation at maximum operational levels. Under most operational parameters, the system operates at energy volumes well below the maximum level possible but can be scaled up rapidly toward maximum operational levels to meet high need periods

The circulation pipe installed in the borehole is essentially a pipe within a pipe, comprising a closed circulation loop of pipes connected to a turbine system. A small diameter pipe is mounted inside a larger diameter pipe along the longitudinal axis of the larger pipe. Mounts between the inner pipe and the outer pipe are sized and positioned to minimize and limit turbulence in the flow of working fluid through the pipeline. Other embodiments of the invention permit mounting the inner pipe in a position offset from the longitudinal axis of the larger pipe. Such an alternative placement may be needed to take advantage of the flow characteristics of a certain working fluid. The combination of pipes is placed in the borehole along the full length of the vertical and horizontal bores and cemented into place in the rock formation. One or more types of high or low conductivity cement may be used to optimize heat uptake in some areas or to provide insulation from heat loss in other areas. These are placed strategically in the borehole with the pipeline to optimize performance. High conductivity cement may, for example, be placed in horizontal pipeline locations to aid heating the working fluid. Low conductivity cement may be placed in the vertical pipeline to limit heat uptake in the working fluid before it reaches the horizontal pipeline. At the bottom (in-hole) end of the circulating pipe, the inner pipe is open-ended while the outer pipe is capped with a generally hemispherical cap. Different embodiments of the invention permit different shapes for the end of the outer pipe, such as a flat cylinder or other design specific to optimize flow of the working fluid between the two pipes.

In the preferred embodiment, a working fluid is pumped at high volumes into the outer pipe where it flows through the length of the pipeline to the hemispherical cap at the bottom end of the circulating pipe. There, the hemispherical cap directs the flow of the working fluid into the inner pipe. The pipeline is encased along its entire length in the borehole with at least one type of cement to place it in direct contact with the hot rock formation. As a result, the outer pipe in the horizontal borehole is maintained at approximately the same temperature as the rock formation. This contact with the hot rock formation results in the heating of the fluid in the outer pipe as the working fluid is pumped through the system of pipes.

The temperature of the rock formation is sufficient to vaporize the working fluid in the pipeline but vaporization is prevented by keeping the fluid under sufficiently high pressure to maintain single phase fluid. As a result of the pressurization of the working fluid, the working fluid is superheated when it exits the pipeline back at the surface. To maintain the heat in the working fluid as it returns to the surface, insulation may be disposed between the inner pipe and the outer pipe.

In an alternate embodiment, the pump pumps the working fluid into the inner pipe of the pipeline to the bottom of the pipe system. In this embodiment, the working fluid exits the inner pipe and is directed into the hemispherical cap, which then directs the flow into the outer pipe. The working fluid in this alternate embodiment is heated on the return trip to the surface by contact between the outer pipe and the rock formation. Again, insulation between the inner pipe and the outer pipe can be disposed to prevent unwanted heat flow in the system.

High pressure/high volume fluid flows can commonly result in turbulent flow which impedes and disrupts flow characteristics of a pumped fluid. Turbulence can then increase operational costs and, equally, reduce the amount of flow of working fluid in the pipeline. It also limits the ability to scale up operations. Known geothermal systems rely on rifling of the interior of the outer pipe or internal flow moderators to maintain generally linear or non-turbulent flow through the pipes. These mechanisms increase construction and operational costs of such systems. Other embodiments of geothermal wells are not closed but are “open,” in that water or some other working fluid is caused to flow between an injection well and one or more uptake wells through hot subterranean rocks that the operators typically must fracture, adding to construction expense and potentially triggering earthquakes. These types of systems also rely on reservoirs of fluid to be injected and/or reservoirs of fluids withdrawn from the well. These systems make it difficult to scale operations up or down. Likewise, construction costs are high owing to the need to drill at least two complete wells.

The present invention uses a surface coating on the interior of the outer pipe and the exterior and interior of the inner pipe to facilitate linear flow through the pipes. Structures needed to mount the inner pipe coaxially or otherwise within the outer pipe are kept to a minimum and are designed to minimize flow disruption. Linear flow is further maintained by computer control of the injection and withdrawal of the fluid. These improvements permit full scalability of the flow. The only mechanical impediments to flow are spacers which maintain the position of the inner pipe relative to the outer pipe and which are disposed throughout the length of the pipeline.

Once the superheated working fluid is returned to the surface, the heat is extracted using an Organic Rankine Cycle Engine or similar device. In the preferred embodiment, pressure is released from the working fluid when it exits the pipeline, causing some of it to vaporize. Most of the heat of that vaporization goes into the vapor. The vapor is passed through a heat exchanger, which transfers the heat to water (or smart fluids, i.e. specially designed CO2 based fluids that have superior vaporization characteristics) causing it to boil into steam/vapor. The vapor/steam drives a turbine, generating electricity. In other embodiments, the working fluid may be vaporized while it passes through the pipeline and the heated vapor is returned to the surface to drive the Organic Rankine Cycle Engine. In other embodiments, the heated working fluid is vaporized to provide heat to create steam to drive a double- or triple flash turbines.

The design of the system allows the rate of pumping of fluid into and through the pipeline to be broadly scalable. This permits broad scalability of the conversion of the superheated fluid into a hot vapor and likewise the production of steam to be broadly scalable dispatchable baseload power generation system.

### FIGURES

FIG. 1 depicts a graph showing the rise is temperature of subsurface rocks with increasing depth.

FIG. 2 depicts a cutaway partial side view of the inner pipe inside the outer pipe of the pipe system.

FIG. 3 depicts a cutaway top view of the pipe system.

FIG. 4 depicts a standard layout of the pipe system in rock formations of the desired temperatures.

FIG. 5 depicts elements of the surface operations of the geothermal system, including the fluid pump and Organic Rankine Engine.

FIG. 6 depicts a cutaway side view of the structure of the bottom of the pipe system further depicting the open-ended inner pipe and an embodiment of the closed hemispherical cap of the outer pipe.

FIG. 7 depicts the flow characteristics of the fluid through the pipe system.

FIG. 8 depicts the temperature rise of the fluid through the pipe system

FIG. 9 depicts a representation of the entire system.

### DETAILED DESCRIPTION OF THE INVENTION

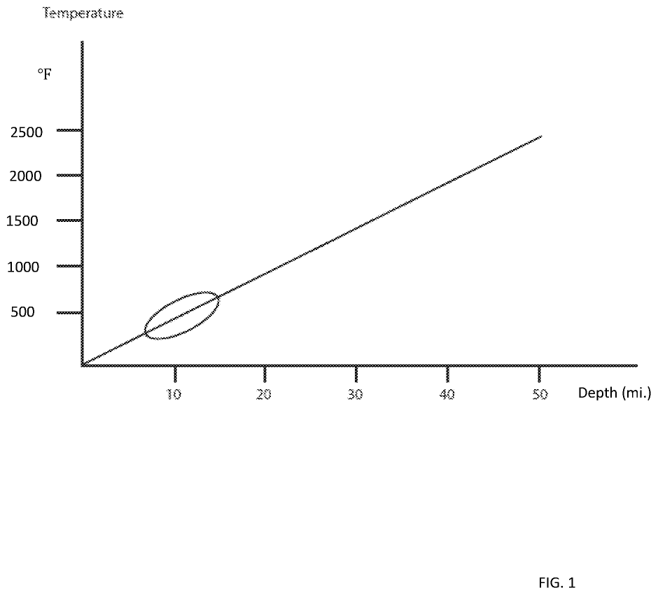

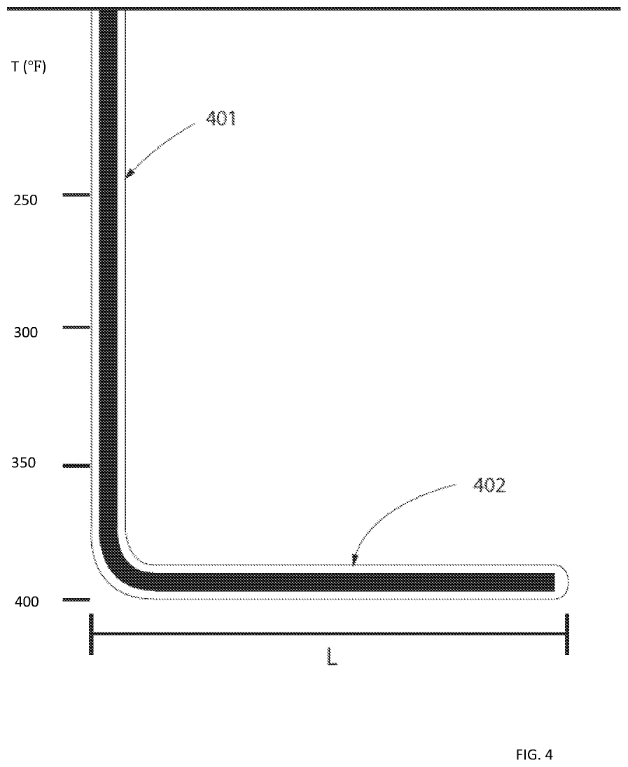

The preferred embodiment of the invention takes advantage of the high temperatures of subsurface rocks in the Earth to heat a working fluid under pressure in order to drive a surface electrical generator using the heat taken up by the working fluid. As depicted in the graph of FIG. 1, almost immediately below the Earth's surface, temperatures of subsurface rock formations start to rise. At depths of 5,000 feet to 35,000 feet, temperatures may range from 300° F. to 600° F. Ideal temperatures can be obtained at shallower depths near hot spots in the Earth. The oval in FIG. 1 represents a general range of useful temperature and known depths into the Earth. Referring to FIG. 4, the position of a pipeline in subsurface rocks is depicted. A vertical hole 401 is drilled downward into the Earth to a suitable depth where the rock formation is at the desired temperature. The numbers to the left of the vertical hole 401 depict the temperature of the surrounding rock formation in an embodiment. At the desired temperature, a substantially horizontal hole 402 extending from the vertical hole 401 is drilled to a length (designated as element L in FIG. 4) to enable the transfer of sufficient heat from the rock formation into a working fluid to be pumped through a closed circulation pipeline to be installed in the vertical hole 401 and horizontal hole 402. Thus, the horizontal hole 402 is drilled to run through rocks of an optimal temperature. The length L of the horizontal hole 402 must allow sufficient heating of the working fluid when pumped at various rates of flow. The length L of the horizontal hole 402 includes an additional length sufficient to permit the system to be operated safely at any pumping rate. The length L of the horizontal hole may depend in part on the temperature sought for operations. This may depend further on the type of working fluid used. A lower temperature system may use liquid CO2 while a higher temperature system may use pentene.

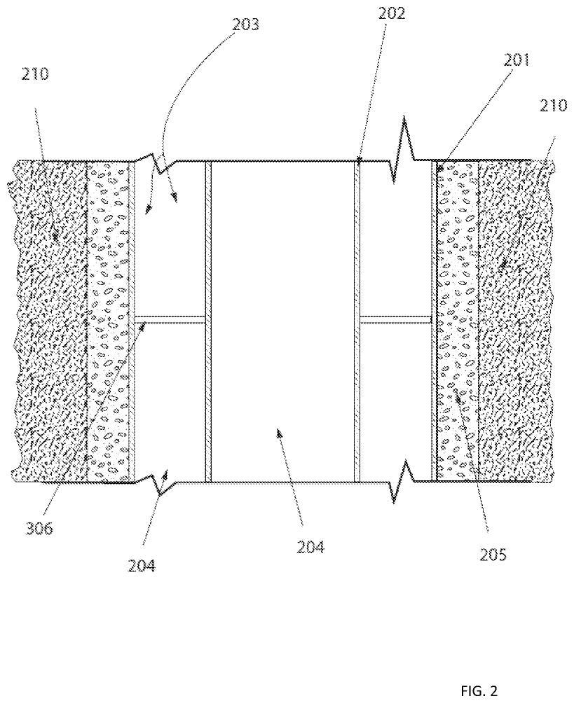

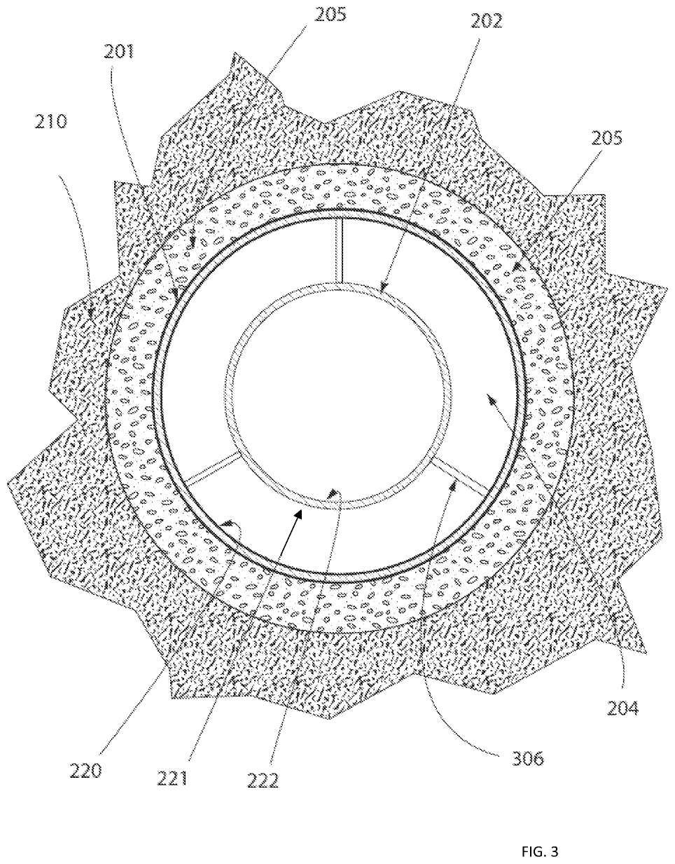

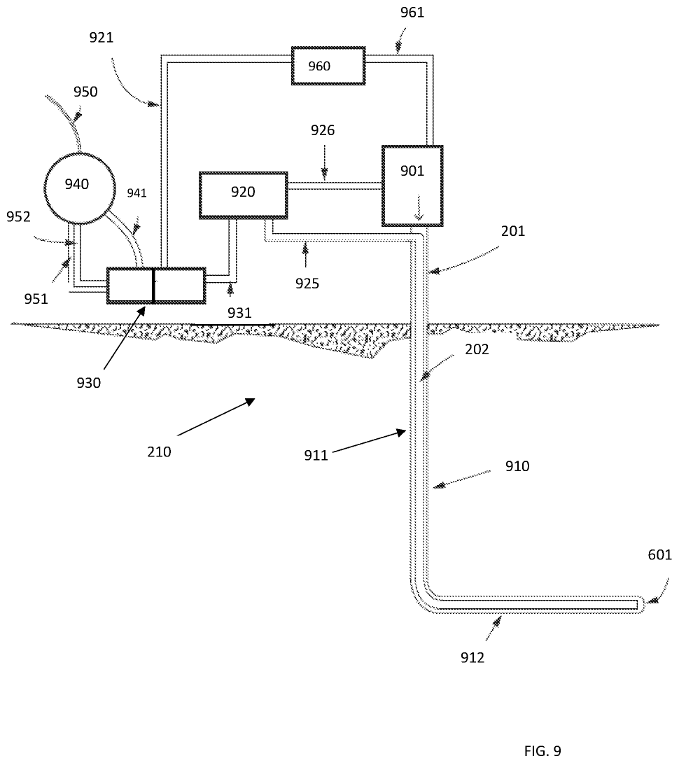

FIG. 2, FIG. 3 and FIG. 9 depict the operational components of the invention, including the borehole, a working fluid circulation pipeline disposed in the borehole and the electricity generation equipment at the surface which uses heat taken up by the working fluid pumped through the circulation pipeline to power a turbine for generating electricity. Referring first to FIG. 9, a pump 901 is used to pump a working fluid into the intake pipe 201, which in this embodiment is the outer pipe of the circulation pipeline disposed through the length of a borehole 910. The working fluid is pumped down the length of intake pipe 201 to hemispherical cap 601, where the working fluid is directed into the outflow pipe 202 to return to the surface. In order to limit heat exchange between the intake pipe 201 and the outflow pipe 202, insulation (not depicted) may be disposed between elements of the intake pipe 201 and the outflow pipe 202.

At the surface, in one embodiment the working fluid is conveyed by a flash chamber pipeline 925 to a flash chamber 920 and other elements of an Organic Rankine Cycle engine suitable to extract the heat contained in the working fluid to drive a turbine 940 to produce electricity. In other embodiments (not depicted) a similar assembly may be used to extract heat using a double- or triple-flash turbine. The preferred assembly depends on factors which may include the type of working fluid used and the temperature of the rock formation.

Referring to FIG. 2 and FIG. 3, an intake pipe 201 has mounted coaxially inside it a smaller diameter outflow pipe 202. In other embodiments of the invention, outflow pipe 202 may be mounted off-set from the longitudinal axis of the intake pipe 201. In still other embodiments of the invention, the intake pipe 201 may be the inner pipe and the outflow pipe 202 may be the outer pipe in the circulation pipeline. The combined intake pipe 201 and outflow pipe 202 are installed along the length of borehole 910 drilled as depicted in FIG. 9 and encased in a geopolymer or other cements 205 with either high conductivity or low conductivity properties, depending the wellbore conditions. Borehole 910 is comprised of a vertical borehole 911 and a horizontal borehole 912. Again, insulation (not depicted) may be disposed between the intake pipe 201 and outflow pipe 202. Similarity, the type of cement in which the pipeline is encased depends on whether conductivity or insulation is sought relative to thermal contact between the pipeline and the rock formation. For example, in the vertical borehole 911, an insulative cement may be used to maintain the temperature of the working fluid until it reaches the horizontal borehole 912, described below. In the horizontal borehole, a highly conductive cement may be used to promote heat conduction into the working fluid.

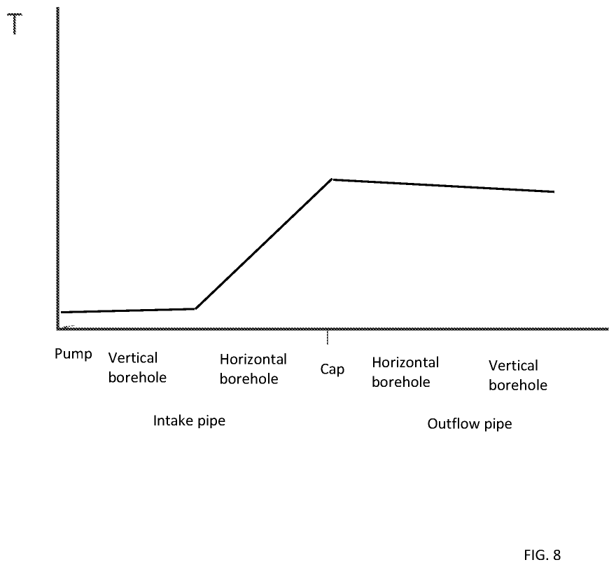

Vertical borehole 911 is drilled from the surface to a depth at which the subsurface temperatures of the rock formation in which the borehole is drilled meet or exceed the energy requirements necessary to heat a working fluid pumped through the pipeline. When the vertical borehole 911 is at the desired depth based on rock formation temperature, the borehole 910 is turned to run substantially horizontally in some applications, as depicted by horizontal borehole 912. Horizontal borehole 912 need only be approximately horizontal. For clarity, horizontal borehole 912 is the same as horizontal hole 402, and vertical borehole 911 is the same as vertical hole 401. The horizontal borehole 912 may rise or fall within the known exactness of subsurface drilling so long as the rock formation in which the horizontal borehole 912 lies remains a rock formation of a suitable temperature. Referring to FIG. 8, the graph depicts the expected temperature rise of the working fluid as it is pumped through the pipeline in an embodiment. In the vertical borehole, insulative cement maintains the working fluid at approximately the temperature of injection. In the horizontal borehole, conductive cement promotes rapid heating of the working fluid. At the cap, the insulated outflow pipe 202 maintains the temperature of the working fluid with minimal loss of energy.

Referring again to FIG. 9, the length of the substantially horizontal borehole 912 is determined by the amount of heat needed to be absorbed by the working fluid. The primary factors which determine the length of the horizontal borehole 912 include (i) the temperature of the rock formation at the level of the horizontal borehole 912, (ii) the coefficient of heating of the working fluid, (iii) the heat transfer characteristics of the intake pipe 202 and the heat transfer characteristics of the geopolymer or other well cement 205 either with high or low conductivity depending on its placement within the wellbore 910 in which it is encased, and (iv) the maximum rate of flow of the working fluid through the pipeline (which may equally be considered as the time during which the working fluid is in the pipeline and in thermal contact with the steel wellbore and it in turn is in contact with cement that is in contact hot rock formation). Additional factors may include the circumferential surface area of the outflow pipe 202 relative to the surface area of the intake pipe 201. The length of the pipeline generally exceeds maximum operational levels in order to ensure the system is operated safely. The system is typically operated to meet average electrical needs but can be increased to meet high demand levels while still operating at a safe level less than maximum capacity.

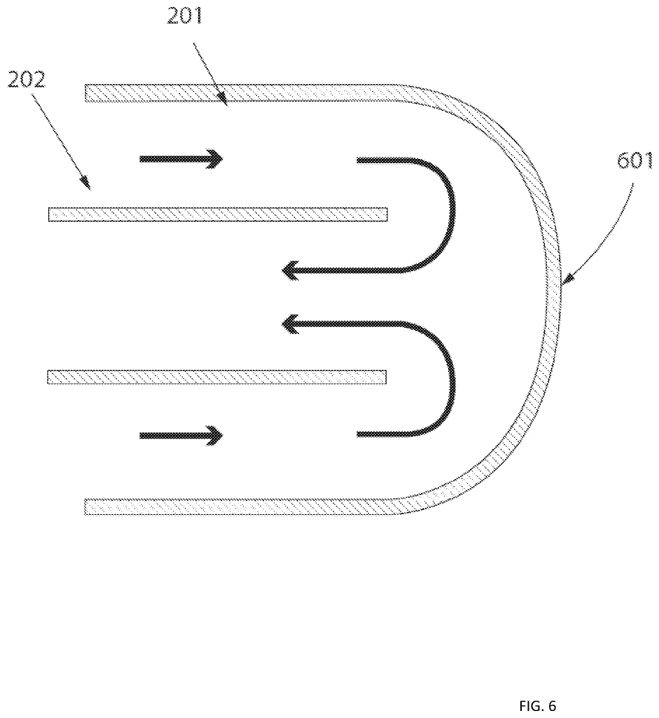

As depicted in FIG. 6, intake pipe 201 is capped at the downhole end of the horizontal element of the intake pipe 201 with a hemispherical cap 601. Outflow pipe 202 is open ended, with the open end of outflow pipe 202 located away from the hemispherical cap 601 at a sufficient distance to permit smooth flow of the working fluid from intake pipe 201 through the hemispherical cap 601 and into the outflow pipe 202. This allows the working fluid pumped through the system to circulate through the pipeline. The hemispherical cap 601 causes the flow direction to change and flow into outflow pipe 202. Although the hemispherical cap 601 is depicted in FIG. 6 as hemispherical, other shapes and flow direction devices may be used to optimize redirection of the flow of the working fluid from the inflow pipe 201 into the outflow pipe 202.

Referring again to FIG. 9, the working fluid is pumped by pump 901 through the length of intake pipe 201 where, in the horizontal borehole 912, the working fluid is heated by conductive contact with the hot rock formation 210 and geopolymer cement or normal oil and gas cements 915. After the working fluid is redirected in the hemispherical cap 601, the heated working fluid is returned to the surface in the outflow pipe 202 as a superheated fluid.

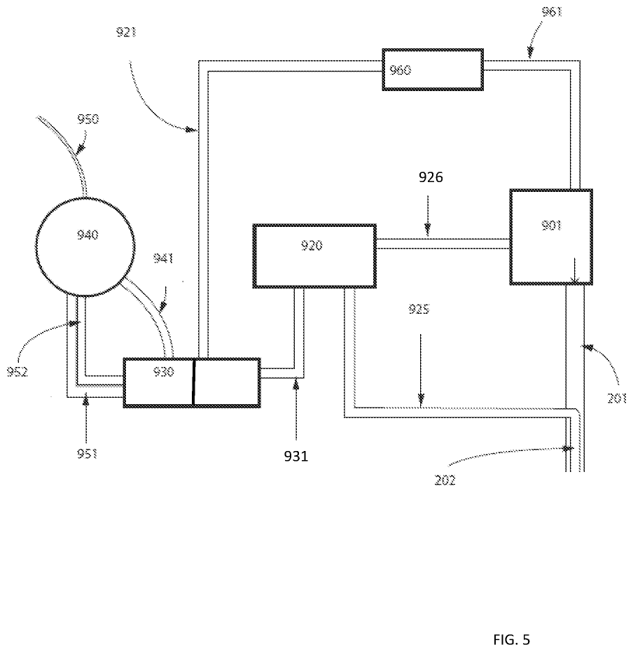

Although the temperature of the working fluid back at the surface exceeds the boiling point of the working fluid under standard pressure, in this embodiment the working fluid is maintained under sufficient pressure in a single-phase fluid to prevent boiling while in either the intake pipe 201 or the outflow pipe 202. As depicted in FIG. 9 and FIG. 5, at the surface, in the embodiment using an Organic Rankine Cycle engine, the superheated working fluid enters a working fluid-flash chamber pipeline 925 which transports the working fluid to a flash chamber 920 and then to a chambered water tank 930 where it is placed in working contact with water or a similar other turbine-driving fluid. For the purpose of this embodiment, the turbine fluid is water. Energy from the superheated working fluid flows into the water, boiling it into steam. While approximately 25% of the working fluid vaporizes, the rest remains in liquid form in the flash chamber 920. The liquid working fluid is cooled and returned to pump 901 for reuse via a return pipe 926. A similar assembly is used in other embodiments.

In another embodiment, the release of the energy from the working fluid may be directly from the superheated working fluid (still in liquid form) or by releasing pressure on the superheated working fluid, thereby permitting the superheated working fluid to vaporize. Heat in the vapor then flows into the water, likewise converting water to steam in the flash chamber 920. In another embodiment, the working fluid may be boiled off in the intake pipe 201, to return to the surface as a hot vapor. This hot vapor is then put into working contact with the turbine fluid.

Still referring to FIG. 5, water is stored in a water tank 930, which is also fluidly connected to the flash chamber 920 by an H20-flash chamber piping system 931 to H2O chamber 930 where is it converted to steam. This steam is then transported to a turbine 940 via a flash chamber-turbine piping system 941. The steam then drives the turbine 940, generating electricity.

Steam passes out of the turbine through an H2O return pipe 952, passing in this embodiment along the length of a conductive cooling element 951, converting steam back to water. The water is then returned to H2O chamber 930.

Referring to FIG. 2 and FIG. 3, details of the configuration of intake pipe 201 and outflow pipe 202 are shown. FIG. 2 depicts a cross-section of the pipes, showing a smaller diameter outflow pipe 202 disposed inside a larger diameter intake pipe 201. In this embodiment, outflow pipe 202 is positioned coaxially within intake pipe 201. Insulation is not depicted but may be disposed between the intake pipe 201 and outflow pipe 202 in a manner which does not alter the disclosed design. In other embodiments, outflow pipe 202 may be positioned eccentrically within intake pipe 201 based on fluid dynamic, heat transfer or other characteristics of the working fluid. In still other embodiments, the shape of the intake pipe 202 and outflow pipe 201 may be elliptical or other non-circular shape in their cross-section.

Still referring to FIG. 2 and FIG. 3, a plurality of mounts 306 are disposed along the length of the pipeline to hold the intake pipe 202 in position inside the outflow pipe 201. The plurality of mounts 306 are minimized in number and size and further are shaped to avoid imposing disruptions or turbulence to the flow of the working fluid. A sample arrangement of a single set of the plurality of mounts 306 are further depicted in FIG. 3.

Still referring to FIG. 3, the inner surface 222 and outer surface 221 of outflow pipe 202 and the inner surface 220 of the intake pipe 201 are coated with a low friction polymer or similar coating 203 to reduce friction on those surfaces to avoid turbulent or other nonlinear flow of the working fluid during operation. In the vertical borehole 910, the intake pipe 201 is encased in a geopolymer cement 205 designed to insulate the pipeline from heat loss on the return trip to the surface. In the horizontal borehole 912, a heat-conducting cement 205 is used to maximize the flow of heat energy between the rock formation and the pipes in order to maximize the heating of the working fluid.

As depicted in FIG. 3, the pipeline system comprised of outflow pipe 202, intake pipe 201 and cement 205 are located within rock formations 210. FIG. 3 further depicts an embodiment of a set of the plurality of mounts 306 used to mount outflow pipe 202 inside intake pipe 201. FIG. 3 further depicts requirements of the cross-sectional area of the pipeline. Outflow pipe 202 has a certain radius. This radius permits a certain volume of flow of the working fluid. The working fluid is a generally incompressible liquid under normal working conditions, including the pressures of pumping. However, the volume of the working fluid will increase slightly as the temperature of the working fluid rises in the pipeline. In addition, although the low friction surface coating 203 is applied to the inner surface 220 of inflow pipe 201, relative to the inflow of the working fluid, and likewise on the outer surface 221 of the outflow pipe 202 and the inner surface 222 of the outflow pipe 202, the friction on these surfaces is not zero. As a result, drag, eddies and turbulence exist at these surfaces. As the working fluid is pumped through the horizontal bore 912, heating of the working fluid expands its volume. Thus, the diameter of the outflow pipe 202 must have a flow volume larger than the flow volume of the intake pipe 201 to allow constant pressure to be maintained. FIG. 2 and FIG. 3 do not necessarily display the actual ratio of radii of the two pipes.

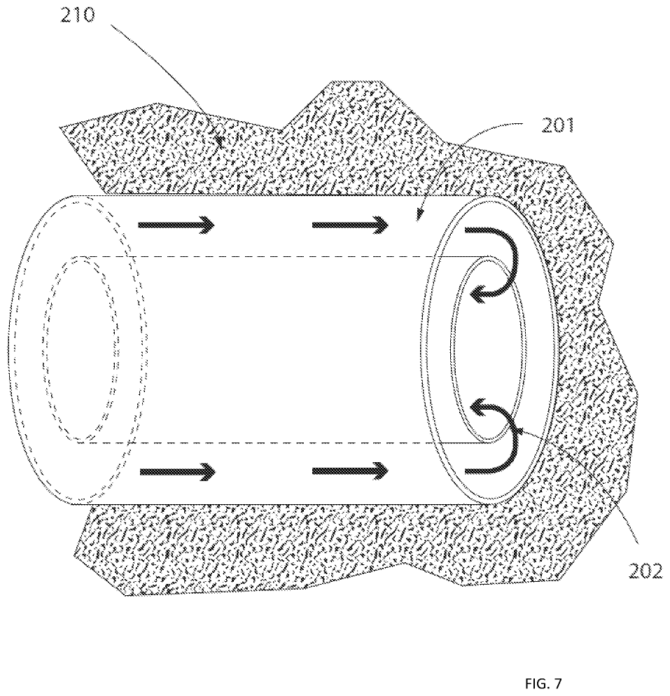

Referring to FIG. 6 and FIG. 7, flow characteristics of the working fluid through the pipeline are depicted. The working fluid flows down into the pipeline through the intake pipe 201 until it reaches the hemispherical cap 601. At this point, the working fluid has reached its maximum temperature. As the working fluid flows into hemispherical cap 601, it is directed into outflow pipe 202. Therein, it is pumped back to the surface. This configuration helps to minimize heat loss during the return of the working fluid to the surface. Hemispherical cap 601 is not depicted in FIG. 7.

Referring to FIG. 5 and FIG. 9, the details of an Organic Rankine Cycle Engine (“ORC”) are depicted. FIG. 5 depicts the elements of the ORC and FIG. 9 depicts the ORC in relation to the pipeline. A pump 901 pumps the working fluid into the outer inflow pipe 201. The working fluid passes through the pipeline and returns with heat to the surface, where it flows out from the outflow pipe 202 through a connector pipe 925 into a flash chamber 920. In the flash chamber 920, pressure is released from the working fluid, which releases heat from the working fluid by vaporization of some of the hot working fluid. The release of pressure is by itself sufficient to boil off about 25% of the working fluid. In an ORC, vaporization results in a vapor containing most of the heat energy and a liquid containing the rest. This vapor is referred to simply as the “vapor.” The vapor is pumped through a vapor pipe 931 to a H2O chamber 930, where the high energy vapor comes into working contact with a water supply. In the H2O chamber 930, the water in working contact with the hot vapor is heated to steam. The steam is then pumped via turbine pump 941 into a turbine 940. The turbine 940 then uses the steam to generate electricity.

Steam exits the turbine 940 via a condenser pipe 952 and passes in thermal contact with a condenser 951, where the steam again becomes water, making it available for reuse. The water is returned to H2O chamber 930. The working fluid vapor exits the second chamber 930 via pipe 921 and enters a condenser 960 to condense the vapor back into a working fluid. The working fluid is then pumped via a pipeline 961 back to the pump 901 for reinjection into the well. A similar process is used in embodiments using double- or triple flash turbine power generation. The ORC or similar power generation works with the scalable nature of the circulation pipeline by allowing for simple increases or decreases in production levels.

In different embodiments, there is no need for a reservoir of working fluid or water. The system can circulate each gas (working fluid vapor or steam) or fluid (working fluid or water) continuously. In other embodiments, a water reservoir, a working fluid reservoir or both may permit holding additional liquids ready for increased energy production in peak demand periods.

In an alternate embodiment, pump 901 pumps a working fluid into the smaller inner pipe 202 as the intake pipe. The pipeline is generally the same as in the preferred embodiment. Likewise cements 910 and 915 remain the same as does the general assembly of surface elements except the connections to the intake pipe 202 and outflow pipe 201 are reversed. In this embodiment, the working fluid flows through intake pipe 202 and into hemispherical cap 601 similarly to that depicted in FIG. 9 but with the intake and outflow pipes reversed. Hemispherical cap 601 redirects the flow of the working fluid into outflow pipe 201. In this embodiment, the shape of the hemispherical cap 601 may be modified to redirect flow from the smaller to the larger pipe. Likewise, expansion of the working fluid does not occur until the working fluid completely departs the intake pipe 202. As a result, the cross-sectional areas of the intake pipe 202 and outflow pipe 201 are approximately the same. In this embodiment, pumping rates of the working fluid must be monitored to account for potential flow disruptions as the working fluid flows through the outflow pipe 201 and expands as it is heated. Given the expansion, the volume of outflow may exceed the volume of inflow.

1. An assembly for the production of a single phase, high enthalpy working fluid unable to generate geothermal power comprising:
(a) a vertical borehole drilled into the Earth to a rock formation at a depth at which the rock formation is of a desired temperature;
(b) an approximately horizontal borehole drilled from the vertical borehole and extending a desired length through the rock formation to ensure sufficient exposure to the rock formation to heat the working fluid to a high temperature to create the high enthalpy working fluid;
(c) in which the vertical borehole and the approximately horizontal borehole each has a diameter sufficient to permit the placement of a first pipeline having a first diameter therein throughout substantially the length of the vertical borehole and the approximately horizontal borehole
in which the first pipeline has disposed there
a second pipeline having a small diameter pipe along
substantially the entire length of the first pipeline a
(e) further comprising a hemispherical cap at the downhole end of the first pipeline
(f) in which the second pipeline disposed within the first pipeline terminates proximal to the hemispherical cap at a position to create a gap between the second pipeline and the hemispherical cap to permit smooth flow of a working fluid between the first pipeline and the second pipeline and
(g) a pump to pump a working fluid under sufficient pressure into one of the first pipeline or second pipeline to cause the working fluid to be pumped through the entire pipeline to make thermal contact with the rock formation in which the pressure imposed on the working fluid by the pump prevents boiling of the working fluid in the entirety of the first pipeline and second pipeline.

2. (canceled)

3. (canceled)

4. The assembly of claim 1 in which the first pipeline is secured in the vertical borehole and the approximately horizontal borehole using a cement.

5. The assembly of claim 4 in which the cement used to secure the first pipeline in place is a geopolymer cement.

6. The assembly of claim 4 in which a plurality of cements is used.

7. The assembly of claim 6 in which at least one cement is used which promotes thermal conductivity between the first pipeline and the rock formation.

8. The assembly of claim 6 in which at least one cement is used which reduces thermal conductivity between the first pipeline and the rock formation.

9. The assembly of claim 1 in which a plurality of spaced and shaped mounts is used to mount the second pipeline within the first pipeline within the vertical borehole and horizontal borehole.

10. (canceled)

11. The assembly of claim 1 in which the pump pumps a working fluid into the first pipeline.

12. The assembly of claim 1 in which the pump pumps a working fluid into the second pipeline.

13. (canceled)
